(19) United States
(12) Patent Application Publication
(10) Pub. No.: US 2026/0264481 A1
(43) Pub. Date: Sep. 10, 2026

(54) VEHICLE WINDOW GLASS AND METHOD OF MANUFACTURING VEHICLE WINDOW GLASS

(71) Applicant: AGC Inc., Tokyo (JP)

(72) Inventors: Satoshi KANEKO, Tokyo (JP); Ryuichi SUMIMOTO, Tokyo (JP)

(73) Assignee: AGC Inc., Tokyo (JP)

(21) Appl. No.: 19/668,593

(22) Filed: May 5, 2026

Related U.S. Application Data
(63) Continuation of application No. PCT/JP2024/038448, filed on Oct. 29, 2024.

(30) Foreign Application Priority Data
Nov. 8, 2023 (JP) 2023-190671

(51) Int. Cl. B60J 1/00; B32B 3/04; B32B 17/10; B60J 10/15; B60J 10/70; B60S 1/02; G02F 1/01

(52) U.S. Cl. CPC B60J 1/001; B32B 3/04; B32B 17/10036; B32B 17/10302; B32B 17/10376; B60J 1/002; B60J 10/15; B60J 10/70; B60S 1/026; G02F 1/0107; B32B 2605/00

(57) ABSTRACT

A vehicle window glass includes a laminated glass mounted in a vehicle-body opening and having first and second glass plates bonded by an interlayer film. A thin electrical component is disposed between the opposed main surfaces of the plates. Wiring connected to the electrical component is routed along the third main surface of the second glass plate, its side surface, and the fourth main surface to a terminal coupled to a vehicle-side wire harness. A resin frame body covers the outer edge of the laminated glass in plan view and covers the wiring. The frame body includes, on the fourth main surface, a frame member that surrounds the terminal in plan view, and a sealing member fills and seals the space defined by the fourth main surface and the frame member.

### CROSS-REFERENCE TO RELATED APPLICATIONS

This application is a continuation application of International Application No. PCT/JP2024/038448 filed Oct. 29, 2024 the disclosure of which is incorporated herein by reference in its entirety. Further, this application claims priorities from Japanese Patent Application No. 2023-190671 filed Nov. 8, 2023, the disclosure of which is incorporated herein by reference in their entirety.

### TECHNICAL FIELD

The present disclosure relates to a vehicle window glass and a method of manufacturing a vehicle window glass.

### BACKGROUND ART

Conventionally, a resin-framed plate-shaped body exists in which a decorative molding is provided at the resin frame of the resin-framed plate-shaped body. The decorative molding is provided with a main body part and a film attached to a surface of the main body part, has a design part exposed at a surface of the resin frame and an embedded part embedded in the resin frame, and the film is attached so as to continuously cover the design part and the embedded part (see, for example, Japanese Patent Application Laid-open No. 2019-209614(Patent Document 1)).

Incidentally, a conventional resin-framed plate-shaped body is a plate-shaped body in which a resin frame is attached to a single glass plate, and for example, is not one in which an electrical component is provided between two glass plates of laminated glass. In a case in which an electrical component is installed between the two glass plates of laminated glass, since cables are required to transmit power, control signals, and the like, there is a possibility that the structure of the frame and its surroundings may become complicated.

### SUMMARY

Therefore, one aspect of the present disclosure aims to provide a vehicle window glass having a simple configuration, including a frame body that covers the outer edge of a laminated glass having a thin electrical component disposed between two glass plates.

A vehicle window glass of an embodiment of the present disclosure includes: a laminated glass having a first glass plate having a first main surface, a second main surface, and a first side surface, a second glass plate having a third main surface, a fourth main surface and a second side surface, and an interlayer film provided between the second main surface and the third main surface, the laminated glass being provided at an opening of a vehicle body; a thin electrical component provided between the second main surface and the third main surface; wiring extending along the third main surface, the second side surface and the fourth main surface between a first end part connected to the thin electrical component between the second main surface and the third main surface and a second end part connected to a wire harness provided at the fourth main surface at a side of the vehicle body; a resin frame body that covers an outer edge of the laminated glass in plan view and the wiring, and that has a frame member provided at the fourth main surface and enclosing the second end part in plan view; and a sealing member that seals a space enclosed by the fourth main surface and the frame member.

According to the present disclosure, a vehicle window glass having a simple structure, including a frame body covering an outer edge of a laminated glass having a thin electrical component provided between two glass plates, and a method of manufacturing a vehicle window glass, can be provided.

### BRIEF DESCRIPTION OF DRAWINGS

FIG. 1 is a diagram showing an example of the configuration of a vehicle window glass 100 of an embodiment.

FIG. 2A is a diagram showing an example of a cross-sectional configuration of the vehicle window glass 100, and is a diagram showing a cross section viewed as per the arrows A-A in FIG. 1.

FIG. 2B is a diagram showing an example of the configuration of a portion enclosed by the dashed-dotted rectangle shown in FIG. 1 as viewed from the −Z direction side (cabin interior side).

FIG. 2C is a diagram showing an example of a configuration in which a frame body 140 (a base part 141, a frame member 142, and a connection part 143) and a silicone resin 150 have been removed from FIG. 2B.

FIG. 2D is a diagram showing an example of a configuration in which a wire harness 20 has been removed from FIG. 2C.

FIG. 3 is a diagram explaining an example of a method of manufacturing the vehicle window glass 100.

FIG. 4 is a diagram explaining an example of a method of manufacturing a vehicle window glass 100M1 of a first modified example of the embodiment.

FIG. 5A is a diagram explaining an example of the cross-sectional configuration of a vehicle window glass 100M2 of a second modified example of the embodiment.

FIG. 5B is a diagram showing an example of the configuration of one portion of the vehicle window glass 100M2 of the second modified example of the embodiment, as viewed from the −Z direction side (cabin interior side).

FIG. 6 is a diagram showing an example of the configuration of one portion of a vehicle window glass 100M3 of a third modified example of the embodiment, as viewed from the −Z direction side (cabin interior side).

### DETAILED DESCRIPTION

Hereinbelow, embodiments to which the vehicle window glass and the method of manufacturing the vehicle window glass according to the present disclosure are applied, are explained. In the following, the same elements are assigned the same reference numerals, and there are cases in which duplicated explanation is omitted.

In the following, there are cases in which the length, width, thickness, and the like of each part is shown in an exaggerated manner so as to make the configuration easier to understand. Further, the terms parallel, right angle, orthogonal, horizontal, vertical, up and down and the like allow for deviation to the extent that the effects of the embodiment are not impaired.

### Embodiment

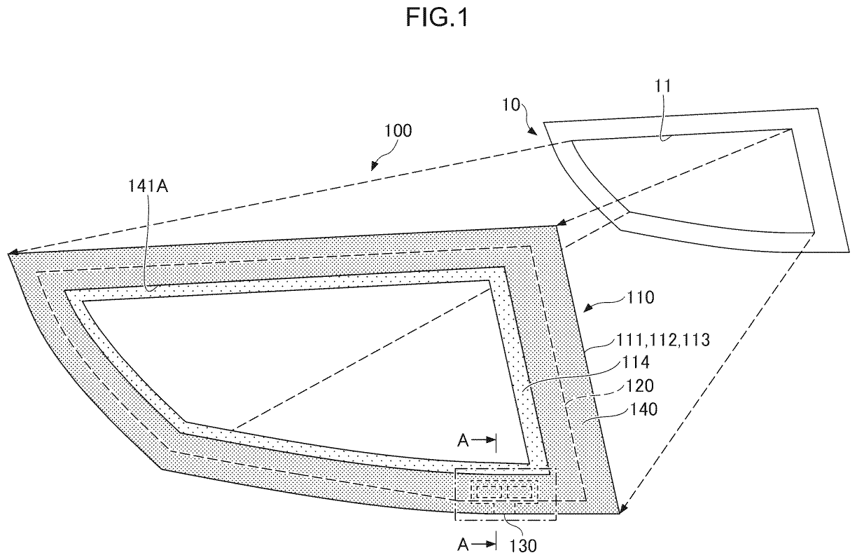

FIG. 1 is a diagram showing an example of the configuration of the vehicle window glass 100 according to the embodiment. FIG. 1 shows an example of the vehicle window glass 100 in an aspect viewed from the cabin exterior side of a vehicle body 10 toward the cabin interior side. Although the vehicle window glass 100 is shown as a flat plate in FIG. 1, the vehicle window glass 100 may be curved in any one direction or two or more directions.

The vehicle window glass 100 is attached to an opening 11 in the vehicle body 10. FIG. 1 shows a portion surrounding the opening 11 of the vehicle body 10. Further, in FIG. 1, the vehicle window glass 100 is shown enlarged relative to the opening 11 in order to facilitate observation thereof.

The opening 11 is a window frame for attachment of the vehicle window glass 100, and is provided with a flange. As an example, the vehicle window glass 100 is attached to the opening 11 from the cabin exterior side, but it may also be attached from the cabin interior side.

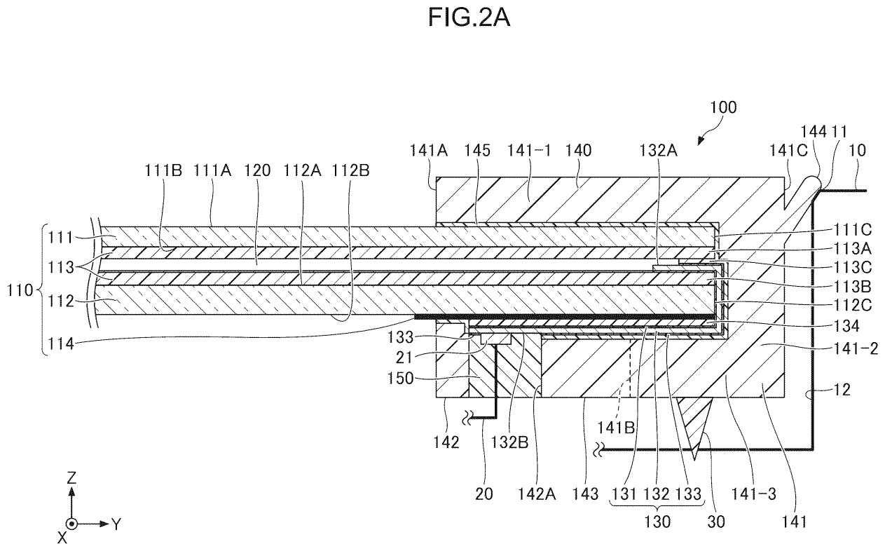

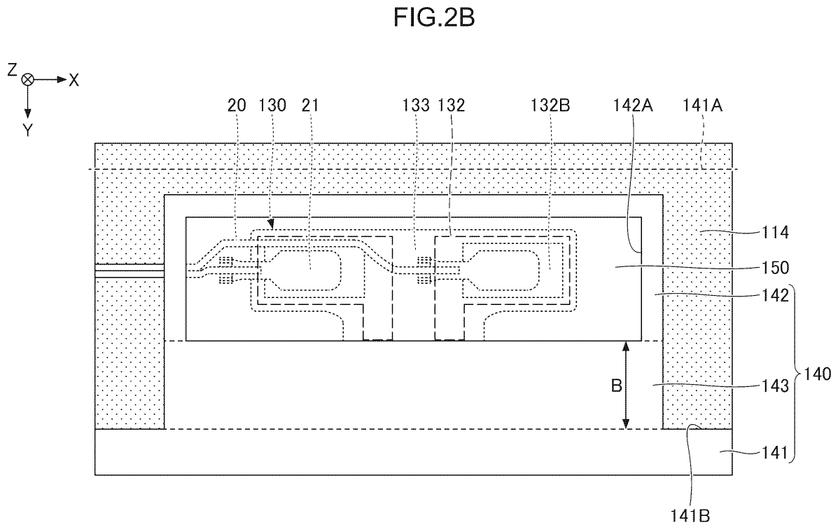

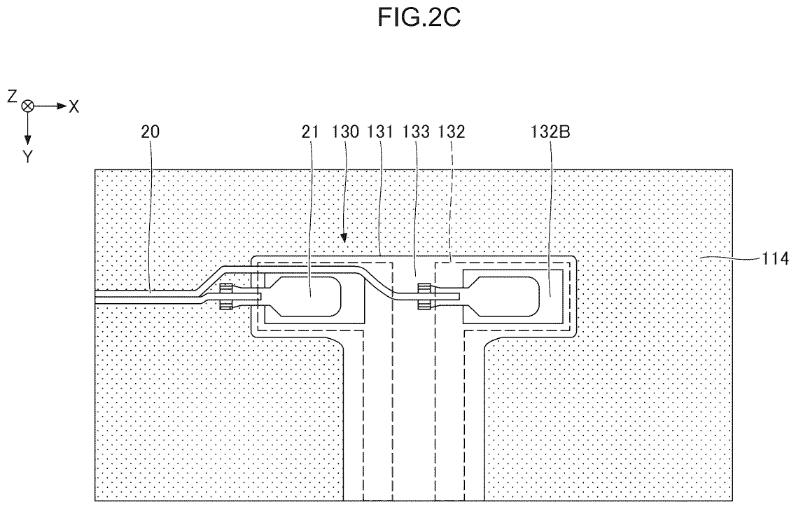

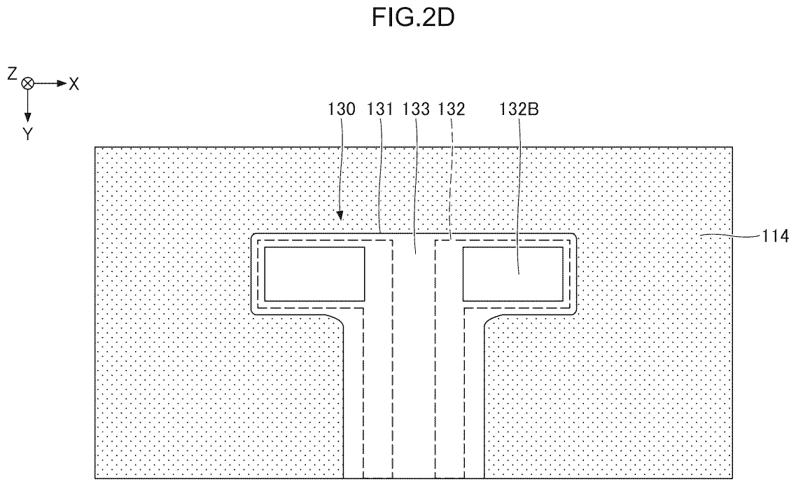

Further, while, in FIG. 1, the planar shape of a laminated glass 110 is roughly an irregular rectangular shape, the planar shape of the laminated glass 110 is not limited to an irregular rectangular shape, and for example, it may be rectangular, trapezoidal, or another quadrangular shape, or triangular, or any other shape. The planar shape here refers to the shape of a predetermined region of the laminated glass 110 as viewed from the normal direction of a fourth main surface 112B (see FIG. 2A) of the laminated glass 110 at the cabin interior side.

The vehicle window glass 100 can be used, for example, as the roof glass, rear glass, side glass, quarter glass, extra glass, windshield, or the like of a vehicle. Here, extra glass is glass that is attached below the rear window of a vehicle in order to improve rearward visibility for the driver of the vehicle. The vehicle, here, refers to an automobile such as an electric vehicle (EV), a plug-in hybrid electric vehicle (PHEV), a hybrid vehicle (HV), a gasoline vehicle, or a diesel vehicle. Further, the vehicle may be a train or steam locomotive.

Further, here, while explanation is made of a mode in which the vehicle window glass 100 is fixed to the opening 11, the laminated glass 110 may be provided so as to be slidable relative to the vehicle body 10. For example, in a case in which the laminated glass 110 is used as a roof glass or a side glass, it may be configured to be openable and closable, relative to the opening 11, by a drive mechanism such as a motor or regulator provided at the vehicle body 10 side.

The vehicle window glass 100 is a Module Assy Window (MAW) (registered trademark) that includes the laminated glass 110 and a frame body 140 provided along the outer edge of the laminated glass 110. Since the vehicle window glass 100 can be installed in the opening 11 of the vehicle body 10 as-is in a state in which the frame body 140 is attached to the laminated glass 110, the assembly process of the vehicle can be simplified.

### Vehicle Window Glass 100

The vehicle window glass 100 includes the laminated glass 110, a light control panel 120, a flexible printed circuit (FPC) 130, the frame body 140 and a silicone resin 150. The light control panel 120 is an example of a thin electrical component. The FPC 130 is an example of a flexible substrate. The silicone resin 150 is an example of a sealing member.

Here, as an example, a configuration in which the thin electrical component is a light control panel 120 is explained; however, the thin electrical component is not limited to the light control panel 120. The thin electrical component may be a functional film, a heating wire or a conductive film for heating, or the like, and the light control panel 120 is an example of a functional film. Thin electrical components other than the light control panel 120 are described below.

The following explanation is made with reference to FIGS. 2A to 2D in addition to FIG. 1. In FIGS. 2A to 2D, XYZ coordinates are defined and explained. The direction parallel to the X axis (X direction), the direction parallel to the Y axis (Y direction), and the direction parallel to the Z axis (Z direction) are perpendicular to each other. The +Z direction side is the cabin exterior side of the vehicle body 10. The Z axis extends in the normal direction of the laminated glass 110. Hereinbelow, a plan view refers to viewing an object in the XY plane in the direction in which the Z axis extends.

FIG. 2A is a diagram showing an example of a cross-sectional configuration of the vehicle window glass 100, and is a diagram showing a cross section viewed as per the arrows A-A in FIG. 1. FIG. 2B is a diagram showing an example of the configuration of a portion enclosed by the dashed-dotted rectangle shown in FIG. 1 as viewed from the −Z direction side (cabin interior side). FIG. 2C is a diagram showing an example of a configuration in which the frame body 140 (base part 141, frame member 142, and connection part 143) and the silicone resin 150 have been removed from FIG. 2B. FIG. 2D is a diagram showing an example of a configuration in which a wire harness 20 has been removed from FIG. 2C. FIG. 2D shows the portion of the FPC 130 that is provided on a shielding layer 114 of the laminated glass 110 as viewed from the −Z direction side (cabin interior side) in an XY plane view. As an example, the shielding layer 114 is provided at a fourth main surface 112B at the cabin interior side of the second glass plate 112 of the laminated glass 110.

FIG. 2A shows a flange 12 provided at the opening 11 of the vehicle body 10. FIGS. 2A to 2C show a wire harness 20 at the vehicle body 10 side, which is not shown in FIG. 1. Further, while interior panels and the like at the cabin interior side of the vehicle body 10 are omitted from FIG. 2A, the FPC 130, the frame body 140, and the wire harness 20 are covered by an interior panel or the like at the cabin interior side of the vehicle body 10 and are, therefore, not visible from the cabin interior side.

### Laminated Glass 110

The laminated glass 110 includes a first glass plate 111, the second glass plate 112, an interlayer film 113, and the shielding layer 114. The laminated glass 110 is formed by bonding the first glass plate 111, which is provided at the cabin exterior side of the vehicle body 10 to the second glass plate 112, which is provided at the cabin interior side of the vehicle body 10 via the interlayer film 113, which is disposed between the first glass plate 111 and the second glass plate 112. Further, the light control panel 120 and the FPC 130 are provided at one portion between the first glass plate 111 and the second glass plate 112.

The total thickness of the laminated glass 110 is preferably from 2.8 mm to 10 mm. The total thickness of the laminated glass 110 is the thickness of the laminated glass 110 between a first main surface 111A of the first glass plate 111 at the cabin exterior side and the fourth main surface 112B of the second glass plate 112 at the cabin interior side. If the total thickness of the laminated glass 110 is 2.8 mm or more, sufficient rigidity can be ensured. Further, if the total thickness of the laminated glass 110 is 10 mm or less, sufficient transmittance can be ensured and the mass does not become excessive. Further, the total thickness here and the thicknesses described below refer to the length in the Z direction.

### First Glass Plate 111 and Second Glass Plate 112

The first glass plate 111 and the second glass plate 112 are transparent plate-shaped glass plates. The first glass plate 111 has a first main surface 111A at the cabin exterior side, a second main surface 111B at the cabin interior side, and a first side surface 111C. The first side surface 111C is an end surface that links the first main surface 111A and the second main surface 111B. The second glass plate 112 has a third main surface 112A at the cabin exterior side, a fourth main surface 112B at the cabin interior side, and a second side surface 112C. The second side surface 112C is an end surface that links the third main surface 112A and the fourth main surface 112B. Here, the first glass plate 111 and the second glass plate 112 may have a flat plate shape or may have a curved shape that is curved in any one given direction or in two or more directions.

The first glass plate 111 and the second glass plate 112 may be inorganic glass or organic glass. As inorganic glass, for example, soda lime glass, aluminosilicate glass, borosilicate glass, alkali-free glass, quartz glass, or the like may be used without any particular limitation. From the viewpoint of scratch resistance, the first glass plate 111 is preferably inorganic glass. Further, from the viewpoints of manufacturing cost and formability, the first glass plate 111 and the second glass plate 112 are particularly preferably soda lime glass. In a case in which the first glass plate 111 and the second glass plate 112 are soda lime glass, clear glass, green glass containing at least a predetermined amount of iron, UV-cut green glass, privacy glass, or the like can be used.

In a case in which the first glass plate 111 and the second glass plate 112 are inorganic glass, the first glass plate 111 and the second glass plate 112 may be either untempered glass or tempered glass. Untempered glass is produced by forming molten glass into a plate shape and slowly cooling. Tempered glass is made by forming a compressive stress layer on the surface of untempered glass, and either air-tempered glass or chemically-tempered glass may be used.

In a case in which the tempered glass is physically-tempered glass (such as air-cooled tempered glass), the glass surface may be strengthened by creating a compressive stress layer at the surface of the glass that is due to the temperature difference between the glass surface and the interior of the glass by means of an operation other than slow cooling such as by rapidly cooling a glass plate, which has been uniformly heated when bending, from a temperature near its softening point. If the tempered glass is chemically-tempered glass, the glass surface may be strengthened by, after bending, generating compressive stress at the glass surface using ion exchange methods and the like. Further, as the first glass plate 111 and the second glass plate 112, glass plates that absorb ultraviolet or infrared rays may be used. While the first glass plate 111 and the second glass plate 112 are preferably transparent, they may also be glass plates that have been colored to an extent that transparency is not impaired.

Further, examples of materials for organic glass include acrylic resins such as polycarbonate and polymethyl methacrylate, and transparent resins such as polyvinyl chloride and polystyrene.

The laminated glass 110 may have a curved shape such that the cabin exterior side is convex when it is attached to the vehicle body 10. The laminated glass 110 may have a single-bend shape that is bent in only one direction, or may have a multiple-bend shape formed by bending in two directions. These two directions are, for example, the up-down direction and the left-right direction perpendicular to the up-down direction when the laminated glass 110 is attached to the vehicle body 10. The laminated glass 110 is bent by gravity forming, press forming, roller forming, or the like. In a case in which the laminated glass 110 is bent to a predetermined curvature, the radius of curvature of the laminated glass 110 may be from 1000 mm to 100,000 mm.

Further, in a case in which the laminated glass 110 is attached to the vehicle body 10, the thickness of the first glass plate 111 located at the cabin exterior side and the thickness of the second glass plate 112 located at the cabin interior side may be the same or may be different. The thickness of the first glass plate 111 is preferably from 1.0 mm to 3.6 mm. When the thickness of the first glass plate 111 is 1.0 mm or more, the strength of the glass plate 111 is sufficient to withstand flying stones and the like, and when the thickness is 3.6 mm or less, the mass of the laminated glass 110 does not become excessive, which is preferable in terms of the fuel efficiency of the vehicle. The thickness of the second glass plate 112 is preferably from 0.3 mm to 2.7 mm. When the thickness of the second glass plate 112 is 0.3 mm or more, the handleability of the second glass plate 112 is favorable, and when the thickness is 2.7 mm or less, the mass of the laminated glass 110 does not become excessive. When the thickness of each of the first glass plate 111 and the second glass plate 112 is 1.8 mm or less, this allows the laminated glass 110 to both be lightweight and have sound insulation properties, which is preferable. Here, in a case in which the thickness of the second glass plate 112 is 1.0 mm or less, the second glass plate 112 may be chemically-tempered glass. In a case in which the second glass plate 112 is chemically-tempered glass, it is preferable that the compressive stress value of the glass surface is 300 MPa or more, and the depth of the compressive stress layer is 2 μm or more. The thickness here preferably refers to the thickness of the thinnest portions of the first glass plate 111 and the second glass plate 112.

The first glass plate 111 preferably has sufficient impact resistance for use in a vehicle. The impact resistance here can be evaluated using, for example, the impact resistance test in UN R43. The impact resistance test is a test to determine whether or not a safety glass, such as laminated glass for automobiles, has the necessary adhesion or strength to withstand the impact of a small, hard flying object. Specifically, the test is performed by holding a laminated glass (safety glass) at a predetermined temperature, and after this, placing the first glass plate 111 in a support frame with the first main surface 111A facing up, and letting a steel ball fall naturally from a specified height.

Further, a coating film that is water-repellent and has an ultraviolet ray and infrared ray blocking function, a coating film that has low reflectance properties, low radiation properties, and antifouling properties, or a coating film that has anti-condensation properties, may be provided to at least one of the first main surface 111A of the first glass plate 111 or the fourth main surface 112B of the second glass plate 112. Further, a coating film that blocks ultraviolet rays and infrared rays, has low radiation properties, absorbs visible light, is colored, or suchlike, may be provided to at least one of the second main surface 111B of the first glass plate 111 or the third main surface 112A of the second glass plate 112. Further, a low-emission coating may be formed at the fourth main surface 112B of the second glass plate 112.

That is, at least one of the first glass plate 111 or the second glass plate 112 may have one or more of any of a water-repellent layer, an ultraviolet blocking layer, an infrared reflecting layer, a low reflectance layer, a low emissivity layer, a dew condensation prevention layer, a visible light absorbing layer, or a colored layer.

### Interlayer Film 113

The interlayer film 113 is provided between the first glass plate 111 and the second glass plate 112. The interlayer film 113 preferably encloses a side surface of the light control panel 120. The side surface of the light control panel 120 is an end surface that connects a surface of the light control panel 120 at the +Z direction side and a surface at the −Z direction side. Here, a first end part 132A of the wiring 132 of the FPC 130 is connected to an end part of the light control panel 120 at the +Y direction side. For this reason, the interlayer film 113, in addition to the side surface of the light control panel 120, encloses a joint part between the light control panel 120 and the first end part 132A, and a portion of the FPC 130 that is positioned between the first glass plate 111 and the second glass plate 112.

The interlayer film 113 has: a first interlayer film 113A bonded to the first glass plate 111; a second interlayer film 113B bonded to the second glass plate 112; and a frame-shaped third interlayer film 113C positioned between the first interlayer film 113A and the second interlayer film 113B and enclosing the side surface of the light control panel 120. In this example, the third interlayer film 113C encloses the side surface of the light control panel 120; however, the third interlayer film 113C does not need to be provided. Even in a case in which the third interlayer film 113C is not provided, if the side surface of the light control panel 120 is positioned further inward in plan view than the first side surface 111C of the first glass plate 111 or the second side surface 112C of the second glass plate 112, at least one of the first interlayer film 113A or the second interlayer film 113B will deform during pressure bonding in the manufacturing process of the laminated glass 110, as a result of which the side surface of the light control panel 120 will be enclosed. In a case in which the thickness of the light control panel 120 is large, since, in plan view, the difference in thickness between the portion at which the light control panel 120 is present and the portion at an outer side relative to the light control panel 120 becomes large, it is preferable to provide the third interlayer film 113C in order to compensate for the difference in thickness.

Here, as an example, a configuration is explained in which the first interlayer film 113A, the second interlayer film 113B, and the third interlayer film 113C are separate bodies that are joined together during the manufacture of the laminated glass 110; however, there is no limitation to this kind of configuration, and for example, in a case in which a highly fluid material is poured in between the first glass plate 111 and the second glass plate 112 to form the interlayer film 113, the interlayer film 113 may be a single integral body.

A thermoplastic resin is often used as the interlayer film 113, and for example, thermoplastic resins that have been conventionally used for this type of application include plasticized polyvinyl acetal resin, plasticized polyvinyl chloride resin, saturated polyester resin, plasticized saturated polyester resin, polyurethane resin, plasticized polyurethane resin, ethylene-vinyl acetate copolymer resin, ethylene-ethyl acrylate copolymer resin, cycloolefin polymer resin, and ionomer resin. Further, a resin composition containing the modified hydrogenated block copolymer described in Japanese Patent No. 6065221 can also be favorably used.

Among these, plasticized polyvinyl acetal resin is preferably used as the material for the interlayer film 113 since it has an excellent balance of properties such as transparency, weather resistance, strength, adhesive strength, penetration resistance, impact energy absorption, moisture resistance, heat insulation and sound insulation. These thermoplastic resins may be used alone or may be used in combination of two or more kinds. The term “plasticized” in the plasticized polyvinyl acetal resin means that the resin has been plasticized by the addition of a plasticizer. The same applies to the other plasticized resins.

However, in a case in which the light control panel 120 is sealed by the interlayer film 113, depending on the type of item being enclosed, deterioration may be caused by certain plasticizers, and in such a case, it is preferable to use a resin that does not substantially contain a plasticizer. That is, there are cases in which it is preferable that the interlayer film 113 does not contain a plasticizer. Examples of resins that do not contain plasticizers include ethylene-vinyl acetate copolymer resins.

Examples of the polyvinyl acetal resin described above include a polyvinyl formal resin obtained by reacting polyvinyl alcohol (in the following, also referred to as PVA) with formaldehyde, a polyvinyl acetal resin in the narrow sense obtained by reacting PVA with acetaldehyde, and a polyvinyl butyral resin (in the following, also referred to as PVB) obtained by reacting PVA with n-butyl aldehyde, and since, in particular, it has an excellent balance of properties such as transparency, weather resistance, strength, adhesive strength, penetration resistance, impact energy absorption, moisture resistance, heat insulation and sound insulation, PVB is a preferable example. These polyvinyl acetal resins may be used alone or may be used in combination of two or more kinds.

As the interlayer film 113, a hardened transparent resin also known as optical clear resin (OCR), or a transparent adhesive sheet also known as optical clear adhesive (OCA) may be used. The use of a hardened transparent resin or a transparent adhesive sheet makes it possible to prepare a laminate (laminated glass) at room temperature, which is more desirable. As the hardened transparent resin or transparent adhesive sheet, an acrylic, silicone, urethane acrylate, epoxy or other resin is used. These curable transparent resins and transparent adhesive sheets may be used alone or may be used in combination of two or more kinds.

The material for forming the interlayer film 113 is not limited to thermoplastic resin. Further, the interlayer film 113 may contain functional particles such as an infrared absorbing agent, an ultraviolet absorbing agent, or a luminescence agent. Further, the interlayer film 113 may have a colored portion called a shade band.

The thickness of the interlayer film 113 is preferably 0.3 mm or more at its thinnest point. When the thickness of the thinnest part of the interlayer film 113 is 0.3 mm or more, the impact resistance required for the laminated glass 110 is sufficient. The thickness of the interlayer film 113 is preferably 3 mm or less at its thickest point. When the maximum thickness value of the interlayer film 113 is 3 mm or less, the mass of the laminated glass 110 does not become excessive. The maximum thickness value of the interlayer film 113 is more preferably 2.8 mm or less, and even more preferably 2.6 mm or less.

The thickness of the interlayer film 113 refers to the thickness of the interlayer film 113 only, excluding the thickness of the light control panel 120. Therefore, the thickness of the interlayer film 113 indicates the length of the thickness from the interface (second main surface 111B) between the first interlayer film 113A and the first glass plate 111 to the interface (third main surface 112A) between the second interlayer film 113B and the second glass plate 112, from which the thickness of the light control panel 120 is subtracted.

Further, the thickest part of the interlayer film 113 is, for example, a portion that the light control panel 120 is not sandwiched between (a portion that does not overlap with the light control panel 120 in plan view). The thinnest part of the interlayer film 113 is, for example, a portion that the light control panel 120 is sandwiched between (a portion that overlaps with the light control panel 120 in plan view).

Further, while it is desirable that the first interlayer film 113A, the second interlayer film 113B, and the third interlayer film 113C included in the interlayer film 113 are all formed with the same material, the first interlayer film 113A, the second interlayer film 113B, and the third interlayer film 113C may be formed partly or entirely with different materials. For example, the first interlayer film 113A and the second interlayer film 113B may be formed with the same material, and the third interlayer film 113C may be formed with a different material.

To produce the interlayer film 113, for example, the above-mentioned resin material that will become the interlayer film is appropriately selected and extruded in a heated, molten state using an extruder. The extrusion conditions such as the extrusion speed of the extruder are set so as to be uniform. Thereafter, the resin film produced by extrusion molding, in order to impart curvature according to the design of the laminated glass 110, is, for example, stretched as necessary, whereby the interlayer film 113 is completed.

### Shielding Layer 114

The shielding layer 114 is an opaque layer. The shielding layer 114 is, for example, an opaque colored (for example, black) ceramic layer. The shielding layer 114 may be a colored interlayer film or a colored film having light-shielding properties, or a combination of a colored interlayer film and a colored ceramic layer. The colored film may be integrated with an infrared reflective film or the like. Here, “opaque” means that the visible light transmittance is 5% or less, preferably 3% or less, more preferably 1% or less, and also includes substantially 0%. The shielding layer 114 suppresses deterioration, due to ultraviolet rays, of a resin, such as urethane, that holds the laminated glass 110 to the vehicle body 10.

The shielding layer 114 can be formed, for example, by applying a ceramic color paste including a fusible glass frit containing a black pigment onto a glass plate by screen printing or the like, and then firing; however, there is no limitation to this. The shielding layer 114 may be formed, for example, by applying an organic ink containing a black or dark color pigment onto a glass plate by screen printing or the like, and then drying.

As an example, the shielding layer 114 is provided in a strip shape along the outer edge of the laminated glass 110. Specifically, as shown in FIG. 1, the shielding layer 114 appears as a strip at an inner side of a frame body 140 that covers the outer edge of the laminated glass 110 in plan view. In FIG. 1, the frame body 140 is indicated by denser dots, and the portion of the shielding layer 114 that is located at an inner side of the inner edge of the frame body 140 is indicated by sparser dots. The portion of the shielding layer 114 indicated by the sparser dots is the portion that is visible from the cabin exterior side in a state in which the vehicle window glass 100 is attached to the opening 11. As an example, since the laminated glass 110 has an irregular rectangular shape in plan view, the frame body 140 has an irregular rectangular track shape in plan view, and the shielding layer 114 also has an irregular rectangular track shape.

As shown in FIG. 2A, for example, at the fourth main surface 112B of the second glass plate 112, the shielding layer 114 is formed so as to straddle the inner edges 141A and 141B of the frame body 140 in plan view. As an example, the outer edge of the shielding layer 114 is positioned at the outer edges of the first glass plate 111 and the second glass plate 112. That is, the shielding layer 114 has a portion that overlaps with the frame body 140 in plan view and a portion that is positioned at an inner side of the inner edges 141A and 141B of the frame body 140 in plan view and does not overlap with the frame body 140. Further, the shielding layer 114 partially overlaps with the light control panel 120 in plan view. Here, as long as the outer edge of the shielding layer 114 is positioned at an outer side of the inner edges 141A and 141B of the frame body 140 in plan view, it may be positioned closer to the center in plan view than the outer edges of the first glass plate 111 and the second glass plate 112.

The width of the shielding layer 114 may be such that it can conceal the frame member 142 of the frame body 140, a portion of the FPC 130 positioned at the fourth main surface 112B, the wire harness 20, and the like. Here, the portion of the FPC 130 positioned at the fourth main surface 112B is a portion of the FPC 130 that is attached to the fourth main surface 112B via the shielding layer 114 and a double-sided tape 134. The width of the shielding layer 114 is the width in the Y direction in FIG. 2A, and is the width of the irregular rectangular track-shaped band portion in FIG. 1. In other words, the width of the shielding layer 114 is the width in a direction perpendicular to the inner edge of the irregular rectangular track-shaped shielding layer 114 in plan view.

The shielding layer 114 is not limited to a configuration in which it is formed at the fourth main surface 112B, and it may be formed at the second main surface 111B of the first glass plate 111 or at the third main surface 112A of the second glass plate 112. The shielding layer 114 may be formed by a combination of the second main surface 111B and the fourth main surface 112B, the second main surface 111B and the third main surface 112A, or the third main surface 112A and the fourth main surface 112B. Further, the shielding layer 114 may be provided at the surface of the first interlayer film 113A or the second interlayer film 113B, or may be embedded inside the first interlayer film 113A or the second interlayer film 113B.

### Light Control Panel 120

The light control panel 120 is an example of a thin electrical component and a functional film. The term “thin” means that the thickness is small enough to be able to be disposed between the first glass plate 111 and the second glass plate 112 of the laminated glass 110.

As shown in FIG. 1, the light control panel 120 has, for example, an irregular rectangular shape in plan view, and is disposed so as to fit within an inner side of the outer edge of the laminated glass 110, which has an irregular rectangular shape in plan view. Here, explanation is given of a configuration in which the light control panel 120 has an irregular rectangular shape in plan view; however, the shape of the light control panel 120 in plan view is not limited to an irregular rectangular shape. The light control panel 120 may be rectangular or have any given shape matching the shape of the laminated glass 110 in plan view. Further, the light control panel 120 may have any given shape that fits within the outer edge of the laminated glass 110, without conforming to the shape of the laminated glass 110 in plan view.

The light control panel 120 is, for example, a member whose transmittance changes depending on power supplied via the FPC 130. Here, as an example, a mode is explained in which the transmittance of the light control panel 120 changes between two stages, a high state and a low state, depending on the presence or absence of power supplied via the two wirings 132 of the FPC 130. When power is supplied via the wiring 132 of the FPC 130, the light control panel 120 turns on and assumes a state of high transmittance, and when the power supply is cut off, the light control panel 120 turns off and assumes a state of low transmittance. The switching between supplying power via the two wirings 132 and not supplying power plays the role of a control signal that switches the light control panel 120 on and off.

However, the light control panel 120 may be a panel whose transmittance changes depending on the duty ratio of a pulse width modulation (PWM) pulse signal, and as an example, may be a light control device whose transmittance changes depending on the duty ratio of a PWM pulse signal, which is affixed to a resin or glass panel. As the light control device, a suspended particle device (SPD), a polymer dispersed liquid crystal device (PDLC), a polymer network liquid crystal device (PNLC), a guest host liquid crystal device, a photochromic device, an electrochromic device, an electrokinetic device, or the like, can be used.

In a case in which the transmittance of the light control panel 120 changes between two stages, in a high transmittance state, it is transparent, and in a low transmittance state, it changes to an opaque state such as gray, and assumes in a state in which it substantially does not transmit light. Further, in a case in which the light control panel 120 is driven by a PWM pulse signal, the transmittance can be controlled in multiple stages between a transparent state and an opaque state, and as an example, in a state in which the duty ratio of the PWM pulse signal is 0%, the transmittance of the light control panel 120 is the minimum.

Among the overall region of the laminated glass 110 in plan view, the light control panel 120 is provided in a region that covers the opening 11. This is because it is disposed at a position that is visible from both the cabin exterior and interior sides of the vehicle body 10. In addition, in a case in which the laminated glass 110 is provided so as to be slidable relative to the vehicle body 10, the light control panel 120 may be provided in a region, among the overall region of the laminated glass 110, that blocks the opening in a state in which the laminated glass 110 is completely closed relative to the vehicle body 10. This is because the laminated glass 110 is disposed at a position that is visible from both the cabin exterior and interior sides of the vehicle body 10 in a state in which the laminated glass 110 is completely closed relative to the vehicle body 10.

Further, as described above, the thin electrical component is not limited to the light control panel 120, and may be a functional film other than the light control panel 120, or an electric heating wire or conductive film for heating.

A functional film is a member that imparts additional functions to the laminated glass 110. Examples of functional films other than the light control panel 120 include a light-emitting display film and a solar cell film. A light-emitting display film is a film-like display device in which pixels configured by a light-emitting element are arranged, and an image can be displayed by passing current through the light-emitting elements of the respective pixels. Light-emitting elements include organic electroluminescence (EL) elements or inorganic EL elements. A solar cell film is a film on which photoelectric conversion elements that convert light energy into electricity are formed.

Further, examples of electric heating wires for heating include an electric heating wire that, for example, functions as a defogger that removes fogging (water droplets) from the surface of the vehicle window glass 100, or an electric heating wire that functions as a de-icer that efficiently melts ice or snow adhering to the outer surface of the vehicle window glass 100. These electric heating wires are made of tungsten wire, for example. The pitch between the heating wires in the X direction is, for example, about 2 mm. In a case in which the electric heating wire functions as a deicer, the value of the current that is passed through the electric heating wire may be set higher (for example, about twice as high) than in a case in which it functions as a defogger. For this reason, an electric heating wire that functions as a deicer is thicker than an electric heating wire that functions as a defogger. An electric heating wire that functions as a defogger is, for example, plural electric heating wires that extend in the horizontal direction and are, for example, arranged at an equal pitch. Further, an electric heating wire that functions as a deicer is, for example, plural heating wires that extend in a vertical direction (up-down direction) perpendicular to the horizontal direction, and are, for example, arranged at an equal pitch.

Further, a conductive film for heating may be a transparent conductive film that functions as a defogger or a deicer. This kind of transparent conductive film can be used in place of the above-mentioned electric heating wire. Examples of the transparent conductive film include a metal film such as an Ag film, a metal oxide film such as an ITO (indium tin oxide) film, and a resin film containing conductive particles. The transparent conductive film may be a laminate of plural types of films.

Further, in a case in which an electric heating wire for heating or a conductive film for heating is provided as a thin electrical component between the first glass plate 111 and the second glass plate 112, an anti-fogging film may be provided at the fourth main surface 112B of the second glass plate 112. The anti-fogging film is, for example, a film that contains a water-absorbent polymer or a hydrophilic polymer and that achieves high water-absorbency.

By configuring the thin electrical component as a functional film, an electric heating wire for heating, or a conductive film for heating, it becomes possible to provide a vehicle window glass 100 including various types of thin electrical component. Further, in the vehicle window glass 100 including various types of thin electrical component, the configuration can be simplified by the structure of the frame body 140 described below.

### FPC 130

The FPC 130 is provided to transmit power, control signals, and the like to the thin electrical component. Here, explanation is given of an aspect in which the vehicle window glass 100 includes the FPC 130; however, instead of the FPC 130, a cable or the like having wiring (conductive wires) covered with an insulating coating may be used.

As an example, as shown in FIG. 1, the FPC 130 is provided at a portion at one side among the outer edges of the laminated glass 110 and the light control panel 120, which have an irregular rectangular shape in plan view.

As shown in FIG. 2A, the FPC 130 includes a substrate 131, a wiring 132, and a cover lay 133. As shown in FIG. 2D, the FPC 130 has a T-shape in plan view, for example. Specifically, the substrate 131 of the FPC 130 has a T-shape in plan view. Two wirings 132 are formed at one surface of the substrate 131 (see FIG. 2D) and are covered with the cover lay 133. The substrate 131 and the cover lay 133 are fixed together by lamination processing, or by bonding with an adhesive, in a state in which the wirings 132 are sandwiched therebetween.

The substrate 131 and the cover lay 133 are made, for example, of a flexible resin film such as polyimide, and the wiring 132 is, for example, wire formed by patterning copper foil or the like.

Each wiring 132 has a first end part 132A (see FIG. 2A) and a second end part 132B (see FIGS. 2A-2D). The wiring 132 is covered by the substrate 131 and the cover lay 133 between the first end part 132A and the second end part 132B. The first end part 132A and the second end part 132B are portions at which the cover lay 133 has been removed and the wiring 132 is exposed on the substrate 131. The second end part 132B functions as a terminal to which the connector 21 of the wire harness 20 is connected.

The portion of the FPC 130 at the side of the first end part 132A is sandwiched between the second interlayer film 113B and the third interlayer film 113C between the first glass plate 111 and the second glass plate 112 at the end part of the laminated glass 110 at the +Y direction side. The first end part 132A is connected to a terminal (not shown) at an end part of the light control panel 120 at the +Y direction side. While, for example, the FPC 130 and the light control panel 120 have an overlapping portion between the first glass plate 111 and the second glass plate 112, there does not need to be any overlapping portion.

The FPC 130, from a portion at the side of the first end part 132A to the second end part 132B in the −Y direction of the second glass plate 112, is folded twice along the second side surface 112C, and extends along the third main surface 112A, the second side surface 112C, and the fourth main surface 112B.

The portion of the FPC 130 that extends along the fourth main surface 112B is attached to the fourth main surface 112B by, for example, a double-sided tape 134 (see FIG. 2A). The portion of the FPC 130 at the side of the second end part 132B is located at the end part in the −Y direction of the portion of the FPC 130 that extends along the fourth main surface 112B. For this reason, the portion of the FPC 130 at the side of the second end part 132B is attached to the fourth main surface 112B of the second glass plate 112 with the double-sided tape 134, for example. That is, the second end part 132B is provided at the fourth main surface 112B via the substrate 131 and the double-sided tape 134.

In this manner, the FPC 130 extends along the third main surface 112A, the second side surface 112C, and the fourth main surface 112B between the first end part 132A and the second end part 132B.

The connector 21 provided at one end of the wire harness 20 is connected to the second end part 132B by soldering. As the solder, a lead-free solder such as silver-tin solder or silver-tin-copper solder can be used, for example. Further, the means of connecting the connector 21 to the second end part 132B is not limited to soldering, and they may be connected by welding, adhesion with a conductive adhesive, or connected by deposition welding. Further, the wires of the wire harness 20 may be directly connected to the second end part 132B without using the connector 21.

As an example, the two wirings 132 of the FPC 130 are provided as shown in FIG. 2D. As an example, the shapes of the two wirings 132 are symmetrical with respect to a line that extends in the Y direction through the center of the T-shaped FPC 130 in the X direction. The two wirings 132 are connected to the positive terminal and the negative terminal of the light control panel 120.

The number of wirings 132 may be determined appropriately depending on the number of terminals of the thin electrical component, and the FPC 130 may have wirings 132 for transmitting control signals and the like in addition to wirings 132 for transmitting power. Further, the shape of the FPC 130 in plan view may be any shape.

The double-sided tape 134 (see FIG. 2A) may be, for example, any double-sided tape capable of adhering the FPC 130 to the fourth main surface 112B of the second glass plate 112. Further, instead of the double-sided tape 134, an adhesive layer or the like may be used.

The FPC 130, which has a structure in which the wirings 132 provided on the substrate 131 are covered with the cover lay 133, is very thin and highly flexible. Therefore, routing when folding from the end part, at the +Y direction side, of the light control panel 120 provided between the first glass plate 111 and the second glass plate 112, along the second side surface 112C and the fourth main surface 112B and connecting the wiring harness 20 to the connector 21 is extremely easy. Further, the ease of routing leads to improved electrical reliability of the wirings 132. This is because the wirings 132 are less likely to be broken or damaged, for example. By using the FPC 130, it is possible to facilitate routing of the wirings 132 and improve electrical reliability.

### Frame Body 140

The frame body 140 is an irregular rectangular frame-like member formed along the outer edge of the irregular rectangular laminated glass 110. The frame body 140 has a base part 141, a frame member 142, a connection part 143 and a lip 144.

As shown in FIG. 1, the frame body 140 is provided continuously around the outer edge of the laminated glass 110; however, it may be formed only at a part of the outer edge of the laminated glass 110, and may be interrupted midway. The frame shape here includes a configuration with a section that is interrupted midway.

The frame body 140 is made of resin, for example. While the resin used for the frame body 140 is not particularly limited as long as it can form a product integrated with the laminated glass 110, the resin can preferably be used in injection molding. Materials that can be used in injection molding are those that can be heated and melted, and can thereafter be solidified by a cooling treatment. Here, as an example, an aspect in which the frame body 140 is produced by injection molding using a mold is explained. A specific method for producing the frame body 140 is explained below.

The resin used for the frame body 140 may be a thermoplastic resin. The resin used for the frame body 140 includes, for example, at least one of a thermoplastic elastomer (TPE) material, a polyvinyl chloride (PVC) material, ethylene propylene diene rubber (EPDM) or a thermoplastic vulcanizate (TPV) material. Thermoplastic elastomer (TPE) materials include olefin-based thermoplastic elastomers (TPO).

When it is produced using a mold, the frame body 140 is formed on a primer 145 for glass after the primer 145, which is for promoting the adhesion of the frame body 140, is applied to the surfaces of the laminated glass 110 and the FPC 130. Here, the surfaces of the laminated glass 110 to which the primer 145 is applied are, for example, the first main surface 111A, the first side surface 111C, the second side surface 112C, and the shielding layer 114 of the laminated glass 110. In a case in which the frame body 140 is provided at a portion at which the shielding layer 114 is not provided, the frame body 140 is formed after applying the primer 145 to the fourth main surface 112B. All of the components that make up the frame body 140 (the base part 141, the frame member 142, the connection part 143, and the lip 144) are integrally molded. That is, the frame member 142 is integrally formed with the frame body 140.

When manufacturing the vehicle window glass 100, a resin frame body that forms the basis of the frame body 140 is formed using a mold, and then unnecessary portions are removed to produce the frame body 140. The operation of removing an unnecessary portion can be carried out, for example, using a cutting tool or the like. Hereinbelow, the structure formed by injection molding using a mold is referred to as a resin frame body. The resin frame body is a resin molded product that forms the basis of the frame body 140, and has a structure in which the frame body 140 and unnecessary portions are combined.

The resin frame body that forms the basis of the frame body 140 is formed without applying a primer to portions of the resin frame body at which unnecessary portions are formed. The unnecessary portions are, in plan view, portions at the cabin interior side at which the frame member 142 and the connection part 143 are not provided at the side of an inner edge 141B, and portions at which an enclosure part 142A (FIG. 2A) is provided inside the frame member 142. In the cross section shown in FIG. 2A, the primer 145 is not present at the portion of the enclosure part 142A. The configuration of each of the base part 141, the frame member 142, and the connection part 143 is explained below.

### Base Part 141

The base part 141 is a frame-shaped portion of the irregular rectangular frame body 140, and is a portion formed along an outer edge of the irregular rectangular laminated glass 110. The base part 141 covers the outer edges and parts peripheral thereto of the first glass plate 111 and the second glass plate 112, as well as the FPC 130, and is sealed in a state in which these are enclosed. The outer edges of the first glass plate 111 and the second glass plate 112 are the first side surface 111C and the second side surface 112C. A peripheral part of the outer edge of the first glass plate 111 is a portion of the first main surface 111A that is close to the first side surface 111C, and a peripheral part of the outer edge of the second glass plate 112 is a portion of the fourth main surface 112B that is close to the second side surface 112C.

Therefore, the base part 141 is provided contacting the portions of the first main surface 111A and the fourth main surface 112B of the laminated glass 110 that are close to the first side surface 111C and the second side surface 112C, and contacting the first side surface 111C and the second side surface 112C. That is, the base part 141 is provided across the first main surface 111A, the first side surface 111C, the second side surface 112C, and the fourth main surface 112B.

Further, in a circumferential direction along the outer edge of the laminated glass 110, the base part 141 may have a section provided only at the first main surface 111A, a section provided only at the fourth main surface 112B, or a section provided only at the first side surface 111C and the second side surface 112C.

The base part 141 has a first portion 141-1 provided at the first main surface 111A, a second portion 141-2 provided at the first side surface 111C and the second side surface 112C, and a third portion 141-3 provided at the fourth main surface 112B.

FIGS. 2A and 2B show an inner edge 141A at the cabin exterior side of the base part 141 and an inner edge 141B at the cabin interior side. In FIG. 2A, the position of the inner edge 141B at the cabin interior side is indicated by a dashed line in order to show a cross section of the portion at which the frame member 142 and the connection part 143 are located at the cabin interior side. Further, in FIG. 2B, the position of the inner edge 141A at the cabin exterior side is indicated by a dashed line in order to show an example of the configuration of the portion enclosed by the dashed-dotted rectangle shown in FIG. 1 as viewed from the −Z direction side (cabin interior side). In FIG. 2B, the position of the inner edge 141B of the base part 141 at the cabin interior side is indicated by a dashed line in the portion at which the connection part 143 is connected to the base part 141.

As an example, the inner edge 141A at the cabin exterior side is located closer to the center of the laminated glass 110 in plan view than the inner edge 141B at the cabin interior side. The fourth main surface 112B at the cabin interior side of the laminated glass 110 is provided with clips or the like for attaching the vehicle window glass 100 to the vehicle body 10. At the time at which the resin frame body that forms the basis of the frame body 140 is produced by injection molding using a mold, the positions of the inner edge 141A at the cabin exterior side of the base part 141 and the inner edge 141B at the cabin interior side are equivalent; however, as an example, a portion of the base part 141 near the inner edge 141B at the cabin interior side is removed. Therefore, the inner edge 141B at the cabin interior side is shifted toward the outer edge side of the laminated glass 110 in plan view relative to the inner edge 141A at the cabin exterior side of the base part 141. As shown in FIG. 2B, the frame member 142 and the connection part 143 protrude toward the center of the laminated glass 110 in plan view beyond the inner edge 141B at the cabin interior side.

With this kind of base part 140, when the vehicle window glass 100 is attached to the opening 11 and the flange 12 of the vehicle body 10, a urethane sealant 30 is applied to the surface (surface of the third portion 141-3) at the cabin interior side (−Z direction side) of the base part 141. The urethane sealant 30 is an example of an adhesive. The urethane sealant 30 provides a seal between the base part 141 and the flange 12. Since the urethane sealant 30 is applied to the third portion 141-3, the laminated glass 110 can be firmly fixed to the vehicle body 10 via the frame body 140.

Further, the reason that the positions of the inner edge 141A at the cabin exterior side of the base part 141 and the inner edge 141B at the cabin interior side are equivalent at the time at which the resin frame body that forms the basis of the frame body 140 is manufactured is as follows. When the resin frame body is produced by injection molding, in order to suppress breakage of the laminated glass 110, it is preferable that the injection pressure that the laminated glass 110 receives is equal at the side of the first main surface 111A and at the side of the fourth main surface 112B. By aligning the position of the inner edge 141A at the cabin exterior side of the base part 141 with the position of the inner edge 141B at the cabin interior side, a region at which the resin frame sandwiches the laminated glass 110 can be made equal at the first main surface 111A side and at the fourth main surface 112B side, and the injection pressure can be made uniform. For such reasons, at the time at which the resin frame body is manufactured, the positions of the inner edge 141A at the cabin exterior side of the base part 141 and the inner edge 141B at the cabin interior side are, for example, equivalent.

### Frame Member 142 and Connection Part 143

The frame member 142 is located at the inner edge side of the frame-shaped base part 141 in plan view. Specifically, the frame member 142 is connected to the inner edge 141B of the base part 141 at the cabin interior side via the connection part 143. The inner edge 141B at the cabin interior side is the inner edge of the third portion 141-3. For this reason, the frame member 142 is connected to the third portion 141-3 via the connection part 143. In this manner, the frame member 142 is integrated with the base part 141.

Further, the frame member 142 is provided straddling a surface, at the −Z direction side, of the shielding layer 114 of the laminated glass 110 and a surface, at the −Z direction side, of a portion of the FPC 130 provided on the fourth main surface 112B. That is, a part of the frame member 142 is provided at the fourth main surface 112B via the shielding layer 114, and the remaining part of the frame member 142 is provided at the fourth main surface 112B via the FPC 130 and the shielding layer 114. The meaning of providing the frame member 142 at the fourth main surface 112B, therefore, includes the shielding layer 114 or the FPC 130 being thus interposed between the frame member 142 and the fourth main surface 112B.

The frame member 142 and the connection part 143 have equal lengths in the X direction, for example; however, the frame member 142 may be longer than the connection part 143, or the frame member 142 may be shorter than the connection part 143. The frame member 142 and the connection part 143 are provided at a section that is one part in the circumferential direction of the inner edge 141B of the base part 141 at the cabin interior side.

The connection part 143 is, for example, the portion of section B in the Y direction indicated by the double arrow in FIG. 2B. The end of section B on the +Y direction side is the boundary between the inner edge 141B at the cabin interior side of the base part 141 and the connection part 143, and the end of section B on the −Y direction side is the boundary between the frame member 142 and the connection part 143. As shown in FIG. 2A, the thickness of the connection part 143 in the Z direction is, for example, equal to the thickness of the base part 141 and the frame member 142 in the Z direction.

The frame member 142 is provided on the −Y direction side of the connection part 143, and is a frame-shaped portion that encloses the second end part 132B of the wiring 132 of the FPC 130 in plan view. The second end part 132B is a terminal to which the connector 21 of the wire harness 20 is connected. The frame member 142 is, for example, a rectangular frame-shaped portion in plan view. As an example, the frame member 142 is provided at a position overlapping with the first portion 141-1 of the base part 141 in plan view. By configuring thus, when the vehicle window glass 100 is viewed from the cabin exterior side, the frame member 142 is concealed by the first portion 141-1, and the appearance of the vehicle window glass 100 can be improved.

The meaning of frame-shaped in regard to the frame member 142 includes a configuration with a section that is interrupted midway, similarly to the frame shape of the frame body 140. Further, the frame member 142 may be configured to be provided at portions at three of the four sides of a rectangular area in plan view that encloses the second end part 132B of the FPC 130, for example. In this case, for example, the wire harness 20 may be passed through the portion at the remaining side.

Further, the meaning of frame-shaped in regard to the frame member 142 includes, for example, a configuration in which the connection part 143 is connected to a portion at one of the four sides of a rectangular frame-shape, as shown in FIG. 2B. In such a case, the connection part 143 may be connected to a part of the side of the frame member 142 at the +X direction side and/or the −X direction side.

The enclosure part 142A is formed by removing a central portion of the frame member 142 in plan view and penetrating through to the surface of the frame member 142 at the +Z direction side. The enclosure part 142A is a through-hole that exposes the second end part 132B of the FPC 130 at the bottom on the +Z direction side. The enclosure part 142A penetrates the frame member 142 in the Z direction.

The end part of the enclosure part 142A at the +Z direction side faces the FPC 130 and the shielding layer 114. That is, the end part of the enclosure part 142A at the +Z direction side faces the fourth main surface 112B via the shielding layer 114, and the remaining part of the end part of the enclosure part 142A at the +Z direction side faces the fourth main surface 112B via the FPC 130 and the shielding layer 114. In this way, the internal space of the enclosure part 142A is a space enclosed by the inner wall of the enclosure part 142A, which is configured by the through-hole, and by the fourth main surface 112B. Inside this space, the connector 21 of the wire harness 20 is connected to the second end part 132B of the FPC 130 and sealed with the silicone resin 150.

FIG. 2A shows a configuration in which the wire harness 20 passes through the enclosure part 142A and the connector 21 at the tip end thereof is connected to the second end part 132B. This structure is, for example, a structure that is produced by a manufacturing process of forming the frame body 140 having the frame member 142 and the enclosure part 142A, and then, after passing the wire harness 20 through the enclosure part 142A and connecting the connector 21 to the second end part 132B by soldering or the like, sealing with the silicone resin 150.

However, the manufacturing process for the vehicle window glass 100 is not limited to this kind of manufacturing process. For example, the connector 21 may be connected to the second end part 132B by soldering or the like through the wire harness 20, and then, after a mold is assembled, a resin frame body that will form the basis of the frame body 140 is formed, unnecessary portions are removed, and the frame member 142 and the enclosure part 142A are formed, the silicone resin 150 may be filled into the enclosure part 142A. In this case, for example, the wire harness 20 may be routed from between the frame body 140 and the shielding layer 114 to outside of the frame body 140.

Regardless of by which manufacturing method the frame body 140 is formed, since the frame member 142 is formed integrally with the base part 141, the structure of the vehicle window glass 100 can be simplified. Further, since the frame member 142 is formed as a part of the frame body 140 together with the base part 141 and is integrated therewith, there is no need to perform positioning simply in order to form the frame member 142, and when the mold for forming the entire frame body 140 is positioned, the frame member 142 is automatically positioned at the same time. For this reason, a frame member 142 that is positioned with high accuracy can be produced by a simple operation.

Further, while the plural clips or the like for attaching the vehicle window glass 100 to the vehicle body 10 are arranged at the fourth main surface 112B at the cabin interior side of the laminated glass 110, closer to a central side of the laminated glass 110 than the base part 141, unused space remains between the clips. Since the frame member 142 is positioned at an inner edge side of the frame-shaped base part 141 in plan view, it is positioned in this thus unused space, and the frame member 142 can be disposed by effectively utilizing the space between the vehicle body 10 and the laminated glass 110.

### Lip 144

As an example, as shown in FIG. 2A, the lip 144 protrudes obliquely from an outer edge 141C of the base part 141 toward the cabin exterior side, and is provided along the entire outer edge 141C of the base part 141 in a circumferential direction. The lip 144 has elasticity, and when the vehicle window glass 100 is attached to the opening 11 and the flange 12 of the vehicle body 10, the lip is flexed in a state of abutment against the opening 11 of the vehicle body 10. By the lip 144 being flexed, a gap between the base part 141 and the opening 11 is filled, and a configuration is realized that makes it difficult for moisture, dust, or the like to enter between the base part 141 and the flange 12.

### Silicone Resin 150

The silicone resin 150 is a silicone sealer that is filled into the inside of the enclosure part 142A, and is a liquid adhesive. This kind of adhesive is, for example, configured by liquid silicone rubber. If the connector 21 of the wire harness 20 is connected to the second end part 132B of the FPC 130 before the silicone resin 150 is filled into the enclosure part 142A, the connection between the second end part 132B and the connector 21 can be sealed with the silicone resin 150.

The silicone resin 150 seals the space enclosed by the frame member 142 and the fourth main surface 112B. The space enclosed by the frame member 142 and the fourth main surface 112B is the internal space of the enclosure part 142A.

### Method of Manufacturing Vehicle Window Glass 100

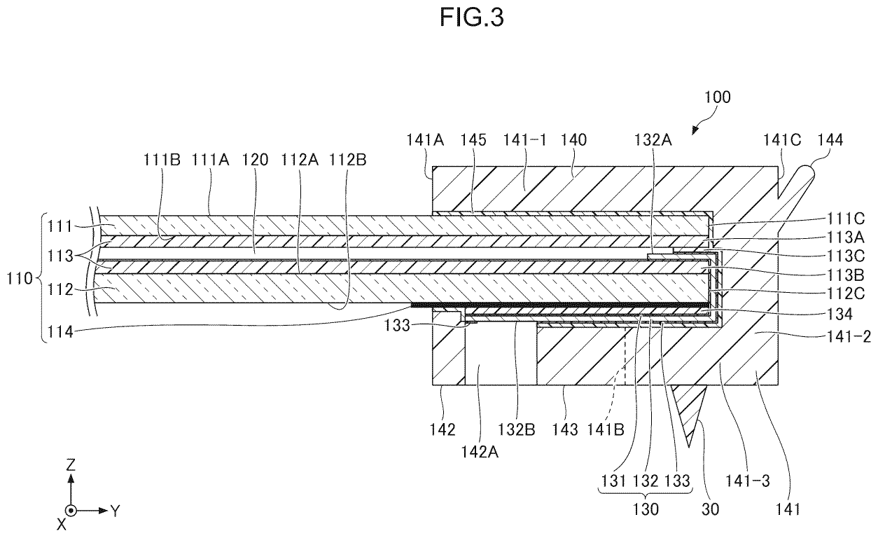

FIG. 3 is a diagram explaining an example of a method of manufacturing the vehicle window glass 100.

The frame body 140 and the vehicle window glass 100 including the frame body 140 are formed as follows. First, the light control panel 120 is sandwiched between the first glass plate 111 and the second glass plate 112 via the interlayer film 113, and the FPC 130 connected to the light control panel 120 is folded along the second side surface 112C and the fourth main surface 112B and attached to the fourth main surface 112B with the double-sided tape 134.

Next, a primer is applied to the surfaces of the laminated glass 110 and the FPC 130. At this time, the primer is applied while avoiding portions at which unnecessary portions that will be removed later are to be formed. The unnecessary portions are the portion at the inner edge 141B side at the cabin interior side at which the frame member 142 and the connection part 143 are not provided, and the portion of the enclosure part 142A.

Next, the laminated glass 110 to which the light control panel 120 and the FPC 130 have been attached is placed in a mold and injection molding is performed, a resin frame body that will become the frame body 140 is formed, and the unnecessary portions are removed. At this stage, the frame member 142 having the enclosure part 142A is formed.

The wire harness 20 is passed through to the enclosure part 142A, and the connector 21 is connected to the second end part 132B by soldering or the like. Finally, the silicone resin 150 is filled into the enclosure part 142A and hardened. In this manner, the vehicle window glass 100 including the frame body 140 can be produced.

In this way, the frame body 140 covers the outer edge of the laminated glass 110 in plan view and the FPC 130. Further, the frame body 140 has a frame member 142 that is provided on the fourth main surface 112B and encloses the second end part 132B (terminal) of the FPC 130 in plan view. Therefore, the frame body 140 can be manufactured together with the frame member 142.

Here, as a different approach from that of the present disclosure, in order to seal the connection between the second end part 132B of the FPC 130 and the connector 21 of the wire harness 20, for example, a sealing structure is conceivable that seals the connection portion by preparing a box-shaped member (referred to below as a box member), connecting the second end part 132B and the connector 21 inside the box member, and filling silicone rubber into the box member. The box member may have a configuration that is can be disposed at the fourth main surface 112B or the surface of the shielding layer 114, and only needs to have a size that enables accommodation of the second end part 132B and the connector 21.

In contrast to this kind of sealing structure, in the vehicle window glass 100 according to the embodiment of the present disclosure, since the frame member 142 of the frame body 140 provided at the outer edge of the laminated glass 110 is used to seal the connection portion between the second end part 132B and the connector 21, the number of parts can be reduced, and the configuration is simplified.

Therefore, according to the embodiment of the present disclosure, a vehicle window glass 100 can be provided that has a simple configuration and includes a frame body 140 that covers the outer edge of laminated glass 110, which is provided with a thin electrical component (for example, a light control panel 120) disposed between two glass plates (a first glass plate 111 and a second glass plate 112).

Further, in a case of filling the inside of the kind of box member described above with silicone rubber, it is necessary to perform a process of fixing the box member to the laminated glass and a filling process. In contrast, in the vehicle window glass 100 according to the embodiment of the present disclosure, in the process of forming the frame body 140 by injection molding, since the frame member 142 for sealing the connection portion of the second end part 132B and the connector 21 can be formed at the same time, the number of work processes can be reduced, the manufacturing process simplified, and the costs reduced.

Further, since the frame member 142 that protects the connection portion of the second end part 132B and the connector 21 is formed integrally with the base part 141, there is no need to perform positioning simply in order to form the frame member 142. When the mold for forming the entire frame body 140 is positioned, the frame member 142 is automatically positioned at the same time, and therefore, a frame member 142 that is positioned with high accuracy can be produced by a simple process.

Further, the base part 141 is very strong because it covers the outer edge of the laminated glass 110 and surrounding parts thereof. Since the connection portion of the second end part 132B and the connector 21 can be protected by the frame member 142, which is formed together with and integrated with this strong base part 141, compared to a case in which a box member is provided at the connection portion between the second end part 132B and the connector 21 and sealed with silicone rubber, the connection portion between the second end part 132B and the connector 21 can be protected for a longer period of time. Further, this improves the electrical reliability of the connection between the second end part 132B and the connector 21.

Further, in a case of using a box member and silicone rubber, it is necessary to provide a mark for position confirmation on the shielding layer 114 when disposing the box member. For this reason, it is necessary to increase the width of the shielding layer 114 to the extent of the size of the mark. In contrast, when the connection portion of the second end part 132B and the connector 21 is covered with the frame member 142 that is a part of the frame body 140, there is no need to provide a position confirmation mark on the shielding layer 114 for sealing. For this reason, there is no need to increase the width of the shielding layer 114, which allows space saving and also enables improvement of the design of the vehicle window glass 100.

In addition, a decorative member may be provided at a surface at the cabin exterior side of the base part 141 of the frame body 140. The decorative member is an exterior member or an interior member primarily intended for decoration of a vehicle window. Further, the frame body 140 may be provided with a control unit that electrically controls the light control panel 120. The control unit may be adhered to the surface of the frame body 140 or may be at least partially embedded therein.

### First Modified Example

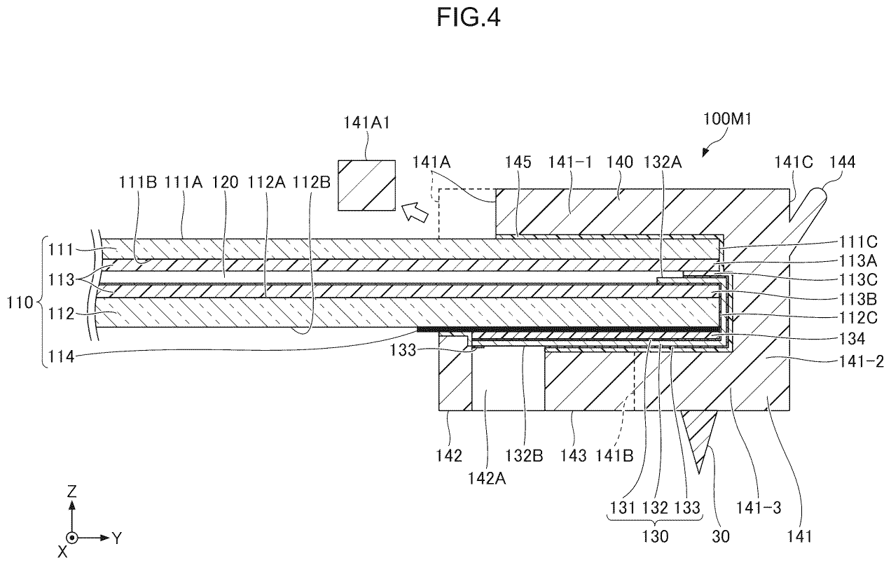

A vehicle window glass 100M1 of the first modified example of the embodiment has a configuration in which a portion along the inner edge 141A at the cabin exterior side of the base part 141 of the frame body 140 of the vehicle window glass 100 of the embodiment is removed. A method for manufacturing this kind of vehicle window glass 100M1 is explained with reference to FIG. 4.

FIG. 4 is a diagram explaining an example of a method of manufacturing the vehicle window glass 100M1 of the first modified example of the embodiment. In the manufacturing process shown in FIG. 4, together with the portion at the inner edge 141B side at the cabin interior side at which the frame member 142 and the connection part 143 are not provided, and the portion of the enclosure part 142A, at the stage of removing unnecessary portions from the resin frame body as explained with reference to FIG. 3, an inner edge part 141A1 along the inner edge 141A at the cabin exterior side is removed.

As shown in FIG. 4, when the inner edge part 141A1 is removed, the inner edge 141A at the cabin exterior side of the base part 141 is shifted toward the outer edge of the laminated glass 110 in plan view from the position indicated by the dashed leader line to the position indicated by the solid leader line. While the positions of the inner edge 141A at the cabin exterior side of the base part 141 and the inner edge 141B at the cabin interior side are equivalent at the time at which the resin frame body that forms the basis of the frame body 140 is manufactured, by removing the inner edge part 141A1, the position of the inner edge 141A at the cabin exterior side can be shifted.

In the vehicle window glass 100M1, the frame body 140 has the frame member 142, which protrudes toward a central side of the laminated glass 110 in plan view. For this reason, when manufacturing the resin frame body by injection molding, the position of the inner edge 141A at the cabin exterior side of the base part 141 is aligned with the portion that is positioned closest to a central side of the laminated glass 110 in plan view among portions that will become the frame member 142.

For example, in terms of vehicle design, in a case in which the position of the inner edge 141A at the cabin exterior side of the base part 141 is to be closer to an outer edge side of the laminated glass 110 than the end of the frame member 142 at the central side of the laminated glass 110 in plan view, as shown in FIG. 4, the inner edge part 141A1 along the inner edge 141A at the cabin exterior side may also be removed.

Here, when applying the primer 145 in the manufacturing process of the vehicle window glass 100M1, application of the primer 145 may be omitted at the region of the first main surface 111A of the laminated glass 110 at which the inner edge part 141A1 is to be formed.

### Second Modified Example

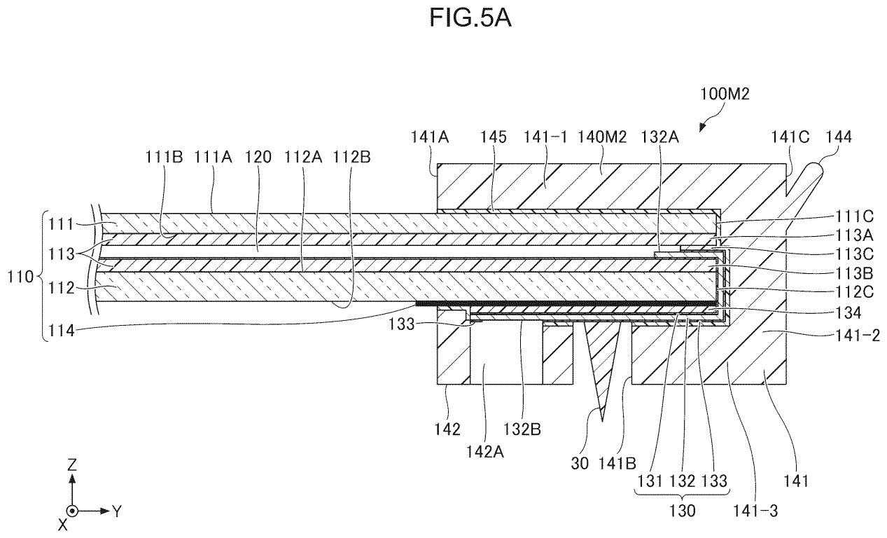

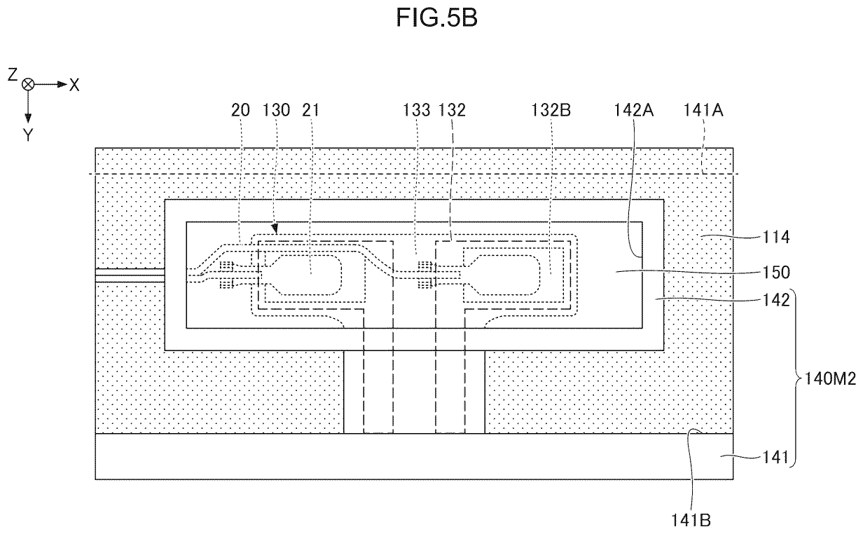

FIG. 5A is a diagram explaining an example of the cross-sectional configuration of a vehicle window glass 100M2 of a second modified example of the embodiment. FIG. 5A shows a cross-sectional configuration of a vehicle window glass 100M2 corresponding to FIG. 2A. FIG. 5B is a diagram showing an example of the configuration of one portion of the vehicle window glass 100M2 of the second modified example of the embodiment, as viewed from the −Z direction side (cabin interior side). FIG. 5B is a diagram showing a portion of the vehicle window glass 100 corresponding to the portion shown in FIG. 2B.

The vehicle window glass 100M2 includes a frame body 140M2 instead of the frame body 140 of the vehicle window glass 100 of the embodiment. The frame body 140M2 has a base part 141 and a frame member 142 that are separated from each other, and does not have a connection part 143.

When manufacturing the vehicle window glass 100M2, at the stage of removing unnecessary portions from the resin frame body that forms the basis of the frame body 140M2, a portion at the side of the inner edge 141B at the cabin interior side at which the frame member 142 is not provided and the portion of the enclosure part 142A may be removed. Here, when applying the primer 145 in the manufacturing process of the vehicle window glass 100M2, application of the primer 145 may be omitted at a portion of the surface of the FPC 130 at the −Z direction side between the inner edge 141B at the cabin interior side of the base part 141 and the frame member 142.

In the vehicle window glass 100M2, since the portion of the surface of the FPC 130 at the −Z direction side between the inner edge 141B at the cabin interior side of the base part 141 and the frame member 142 is exposed, as an example, a urethane sealant 30 can be applied to the exposed portion of the FPC 130. The urethane sealant 30 is applied to the fourth main surface (the exposed portion of the FPC 130) that is exposed by removing the portion of the frame body 140M2 between the frame member 142 and the base part 141. Therefore, the laminated glass 110 can be firmly fixed to the vehicle body 10 via the FPC 130 and the fourth main surface.

The length of the exposed portion of the FPC 130 in the Y direction is, for example, about 10 mm to 15 mm. For example, in the case of a vehicle body 10 in which the depth of the flange 12 is shallow, compared to the vehicle window glass 100 having the urethane sealant 30 applied to the surface in the-Z direction of the third portion 141-3 of the base part 141 as shown in FIG. 2A, the vehicle window glass 100M2 having the urethane sealant 30 applied to the exposed portion of the FPC 130 as shown in FIG. 5A is preferable because the thickness in the Z direction is reduced. The vehicle window glass 100M2 according to the second modified example of the embodiment can be installed in the vehicle body 10 even if the flange 12 is shallow.

In the vehicle window glass 100M2 of the second modified example of the embodiment, a portion between the inner edge 141B at the cabin interior side of the base part 141 and the frame member 142 is removed to produce the frame body 140M2. To remove this portion, a cutting tool or the like may be used. For this reason, after removing this portion, traces of the removal remain at the base part 141 and the frame member 142. This is because scratches or the like remain at the portion at which the base part 141 and the frame member 142 were connected from when they are removed. Therefore, this can be distinguished from a case in which the base part 141 and the frame member 142 are injection molded using a mold configured such that they are separated.

In a case of using a mold configured such that the base part 141 and the frame member 142 are separated, it becomes necessary to inject resin into the portion of the mold corresponding to the frame member 142 separately from the portion of the mold corresponding to the base part 141. In contrast, the frame body 140M2 of the vehicle window glass 100M2 according to the second modified example is easy to manufacture because resin can be injected into the portions of the mold corresponding to the base part 141 and the frame member 142 at the same time.

At the stage of producing the resin frame body that forms the base of the frame body 140M2 by injection molding, since the frame member 142 is formed integrally with the base part 141, and the portion between the base part 141 and the frame member 142 is removed after injection molding, there is no need to perform positioning of only the frame member 142 separately from the base part 141. Further, when performing positioning of the mold for forming the resin frame body that forms the basis for the frame body 140M2, positioning of the frame member 142 is automatically performed at the same time. For this reason, a frame member 142 that is positioned with high accuracy can be produced by a simple operation.

### Third Modified Example

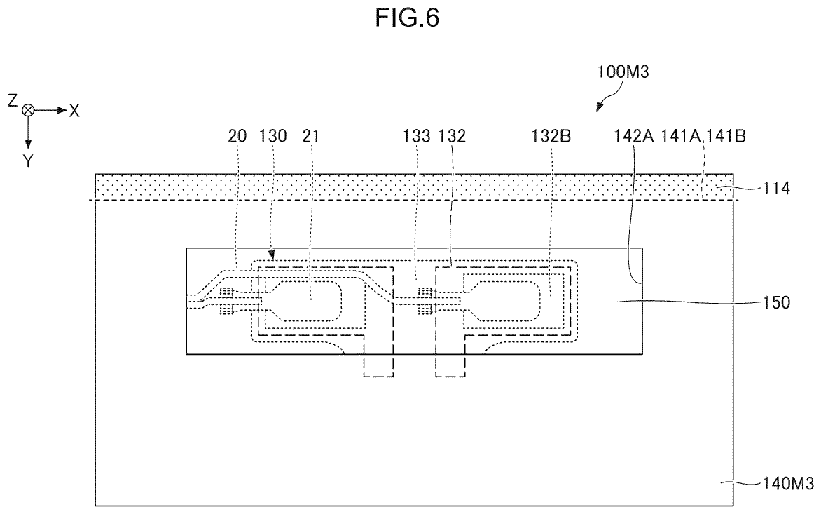

FIG. 6 is a diagram showing an example of the configuration of one portion of a vehicle window glass 100M3 of a third modified example of the embodiment, as viewed from the −Z direction side (cabin interior side). FIG. 6 is a diagram showing a portion of the vehicle window glass 100 corresponding to the portion shown in FIG. 2B.

The vehicle window glass 100M3 includes a frame body 140M3 instead of the frame body 140 of the vehicle window glass 100 of the embodiment. In the process of removing unnecessary portions after producing the resin frame body, the portion of the frame body 140M3 at which the enclosure part 142A is to be provided is removed, while other portions are retained without removal. That is, differently from the frame body 140 of the embodiment (see FIGS. 2A and 2B), in the frame body 140M3, the portion at the side of the inner edge 141B at the cabin interior side at which the frame member 142 and the connection part 143 are not provided is retained without being removed.

The frame body 140M3 has a configuration in which only the portion at which the enclosure part 142A is to be provided is removed from the resin frame body that forms the basis of the frame body 140M3. For this reason, in plan view, the position of the inner edge 141A at the cabin exterior side of the frame body 140M3 is equivalent to the inner edge 141B at the cabin interior side. While the frame body 140M3 includes portions corresponding to the base part 141, the frame member 142, and the connection part 143, it does not have portions having outer profiles arranged as the base part 141, the frame member 142, and the connection part 143.

As an example, at a surface at the cabin interior side of the resin frame body that forms the basis of the frame body 140M3, the enclosure part 142A can be easily produced by marking the portion at which the enclosure part 142A is to be provided and removing the resin from the portion at which the enclosure part 142A is to be provided with a tool or the like.

In a case, for example, in which it is possible to provide a clip or the like for attaching the vehicle window glass 100M3 to the vehicle body 10 on the laminated glass 110 to which the frame body 140M3 is attached, the frame body 140M3 being obtained by removing only the portion at which the enclosure part 142A is to be provided from the resin frame body, a configuration such as the frame body 140M3 may be used. The frame body 140M3 is yet easier to manufacture because it has fewer unnecessary portions. Further, when assembling a mold for manufacturing a resin frame body that forms the basis of the frame body 140M3, since the positioning of the second end part 132B of the FPC 130, and of the position at which the enclosure part 142A enclosing the connection between the connector 21 of the wire harness 20 is to be formed, is also completed, the enclosure part 142A can be manufactured with high precision.

Further, by filling the interior of the enclosure part 142A with the silicone resin 150, the connection between the second end part 132B of the FPC 130 and the connector 21 of the wire harness 20 can be sealed.

Here, when applying a primer during the fabrication of the frame body 140M3, the primer may be applied to the portion covered by the resin frame body excluding the portion that will become the enclosure part 142A.

While exemplary vehicle window glass and methods for manufacturing vehicle window glass of the present disclosure have been explained above, the present disclosure is not limited to the specifically disclosed embodiments, and various modifications and variations are possible without departing from the scope of the claims.

What is claimed is:

1. A vehicle window glass, comprising:
a laminated glass having a first glass plate having a first main surface, a second main surface, and a first side surface, a second glass plate having a third main surface, a fourth main surface and a second side surface, and an interlayer film provided between the second main surface and the third main surface, the laminated glass being provided at an opening of a vehicle body;
a thin electrical component provided between the second main surface and the third main surface;
wiring extending along the third main surface, the second side surface and the fourth main surface between a first end part connected to the thin electrical component between the second main surface and the third main surface and a second end part connected to a wire harness provided at the fourth main surface at a side of the vehicle body;
a resin frame body that covers an outer edge of the laminated glass in plan view and the wiring, and that has a frame member provided at the fourth main surface and enclosing the second end part in plan view; and
a sealing member that seals a space enclosed by the fourth main surface and the frame member.

2. The vehicle window glass of claim 1, wherein the frame member is molded integrally with the frame body.

3. The vehicle window glass of claim 1, wherein the frame body has:
a frame-shaped base part that covers the outer edge of the laminated glass and the wiring; and
a connection part that connects the base part and the frame member.

4. The vehicle window glass of claim 1, wherein:
the frame body has a frame-shaped base part that covers the outer edge of the laminated glass and the wiring, and
a portion of the frame body between the frame member and the base part is removed.

5. The vehicle window glass of claim 3, wherein the frame member is positioned at a side of an inner edge of the frame-shaped base part in plan view.

6. The vehicle window glass of claim 5, wherein:
the base part has:
a first portion provided at the first main surface;
a second portion provided at the first side surface and the second side surface; and
a third portion provided at the fourth main surface, and
the frame member is provided at a position overlapping with the first portion in plan view.

7. The vehicle window glass of claim 6, wherein an adhesive that adheres the vehicle window glass to the vehicle body is applied to the third portion of the base part.

8. The vehicle window glass of claim 4, wherein an adhesive that adheres the vehicle window glass to the vehicle body is applied to the fourth main surface, which is exposed by the portion of the frame body between the frame member and the base part having been removed.

9. The vehicle window glass of claim 8, wherein:
a part of the wiring is exposed at the fourth main surface, which is exposed by the portion of the frame body between the frame member and the base part having been removed, and
the adhesive is applied to the exposed part of the wiring.

10. The vehicle window glass of claim 1, wherein the sealing member is formed with silicone rubber.

11. The vehicle window glass of claim 1, further comprising a substrate extending along the third main surface, the second side surface, and the fourth main surface between the first end part and the second end part, at which the wiring is provided, wherein the wiring and the substrate configure a flexible substrate.

12. The vehicle window glass of claim 1, wherein the thin electrical component comprises a functional film, or an electrical heating wire for heating or a conductive film for heating.

13. The vehicle window glass of claim 1, wherein the first glass plate is positioned at a cabin exterior side of the vehicle body and the second glass plate is positioned at a cabin interior side of the vehicle body.

14. A vehicle window glass, comprising:
a laminated glass having a first glass plate having a first main surface, a second main surface, and a first side surface, a second glass plate having a third main surface, a fourth main surface and a second side surface, and an interlayer film provided between the second main surface and the third main surface, the laminated glass being provided at an opening of a vehicle body;
a thin electrical component provided between the second main surface and the third main surface;
wiring extending along the third main surface, the second side surface and the fourth main surface between a first end part connected to the thin electrical component between the second main surface and the third main surface and a second end part connected to a wire harness provided at the fourth main surface at a side of the vehicle body;
a resin frame body that covers an outer edge of the laminated glass in plan view and the wiring, and that has a through-hole provided at the fourth main surface and exposing the second end part in plan view; and
a sealing member that seals a space enclosed by the fourth main surface and the through-hole.

15. A method of manufacturing the vehicle window glass of claim 1, the method comprising:
providing the interlayer film and the thin electrical component between the first glass plate and the second glass plate;
connecting the wiring to the thin electrical component;
forming the frame body at the outer edge of the laminated glass in plan view, at which the thin electrical component is provided, so as to cover the wiring; and
sealing the space enclosed by the fourth main surface and the frame member.
